(19) United States
(12) Patent Application Publication
(10) Pub. No.: US 2012/0038945 A1
(43) Pub. Date: Feb. 16, 2012

(54) ELECTRONIC SYSTEM

(75) Inventor: Tim Xu, (US)

(73) Assignee: I/O INTERCONNECT, LTD., Santa Ana, CA (US)

(21) Appl. No.: 13/023,589

(22) Filed: Feb. 9, 2011

Related U.S. Application Data
(60) Provisional application No. 61/373,305, filed on Aug. 13, 2010.

(51) Int. Cl. G06F 3/12

(52) U.S. Cl. 358/1.15

(57) ABSTRACT

An electronic system comprises a mobile device for sending a file; a server group for receiving the file from the mobile device; and a printer electrically coupled to the server group. The server group comprises an email server and a printing server. The mobile device sends the file as an email to the email server of the server group. The printing server has a scanning driver and a printing driver installed therein such that the printing server employs the scanning driver to scan the email for determining whether printing the file, and employs the printing driver to drive the printer for printing the file if the file should be printed.

### CROSS-REFERENCE TO RELATED APPLICATIONS

This application is based upon and claims the benefit of priority from the prior U.S. Provisional Application No. 61/373305, filed Aug. 13, 2010, the entire contents of which are incorporated herein by reference.

### FIELD OF THE INVENTION

The present invention relates to an electronic system, and more particularly to an electronic system configured for printing files.

### BACKGROUND OF THE INVENTION

With the rapid development of the technology, mobile device such as personal digital assistant (PDA), mobile phone, smart phone, pocketable computer, e-book reader etc., has been widely applied into the daily work and life of the human, and has more and more functions.

The mobile device generally displays a file, such as an image document, a word document, or an email document, on a display screen thereof. However, the display screen of the mobile device is generally small and is hard for information sharing. It is necessary therefore the file in the mobile device should be printed such that users may report a paper file to leaders or clients. Before printing the file in the mobile device, a printing driver should be installed into the mobile device to drive a related printer for printing the file. Generally, the computing capability and the storing space of the mobile device are limited and the limited storing space and computing capability should be better configured for programs increasing performance but not programs for specific document outputting.

### SUMMARY OF THE INVENTION

Therefore, one object of the present invention is to provide an electronic system, which will not occupy a storing space of a mobile device for printing driver installing.

Another object of the present invention is to provide a printing method for an electronic system, which will not occupy a storing space of a mobile device for printing driver installing.

The present invention provides an electronic system, which comprises a mobile device for sending a file; a server group for receiving the file from the mobile device; and a printer electrically coupled to the server group. The server group comprises an email server and a printing server. The mobile device sends the file as an email to the email server of the server group. The printing server has a scanning driver and a printing driver installed therein such that the printing server employs the scanning driver to scan the email for determining whether printing the file, and employs the printing driver to drive the printer for printing the file if the file should be printed.

In an exemplary embodiment of the present invention, the mobile device sends the file as the email to the email server of the server group by a wireless communication protocol. Preferably, the wireless communication protocol comprises an 802.11 wireless communication protocol or a Bluetooth communication protocol.

In an exemplary embodiment of the present invention, the file is used as an attachment of the email such that the file is sent from the mobile device to the email server of the server group.

In an exemplary embodiment of the present invention, the mobile device is selected from a group consisted of a personal digital assistant, a mobile phone, a smart phone, a pocketable computer and an e-book reader.

In an exemplary embodiment of the present invention, the email server and the printing server are integrated together. Alternatively, the email server and the printing server are two individual servers.

In an exemplary embodiment of the present invention, the printing server employs the scanning driver to scan whether the email has a predetermined content, and if the email has the predetermined content, the printing server drives the printer to print the file by the printing driver. Preferably, the predetermined content is a predetermined word-string.

In an exemplary embodiment of the present invention, the printing server is included in an embedded bridging server, and an Operation System installed in the embedded bridging server such that the scanning driver and the printing driver run in the Operation System. Preferably, the Operation System is the Linux System.

In an exemplary embodiment of the present invention, the embedded bridging server comprises an ARM (Advanced RISC Machines) 32 bit platform. For example, the embedded bridging server comprises an ARM based embedded system and an USB hub. The ARM based embedded system is configured for making the scanning driver and the printing driver run therein. The USB hub is electrically coupled to the printer. Preferably, the USB hub comprises at least one USB interface for being electrically coupled to the printer.

The present invention also provides a printing method for an electronic system, which comprises sending a file as an email to an email server from a mobile device; scanning the email by a printing server with a scanning driver installed therein for determining whether printing the file; and printing the file by the printing server with a printing driver installed therein, if the file should be printed.

The electronic system of the present invention installs the scanning driver and the printing driver in the printing server of the server group instead of the mobile device, such that the scanning driver and the printing driver will not occupy the storing space of the mobile device, and it is not necessary for the mobile device to execute the printing driver. Thus, the mobile device is still convenient in use and has more resources than before for other applications.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of an electronic system in accordance with an exemplary embodiment of the present invention.

FIG. 2 is a block view of the electronic system as shown in FIG. 1.

FIG. 3 is a schematic view of the printing server as shown in FIG. 2.

FIG. 4 is a flow chart of an electronic system in accordance with another exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

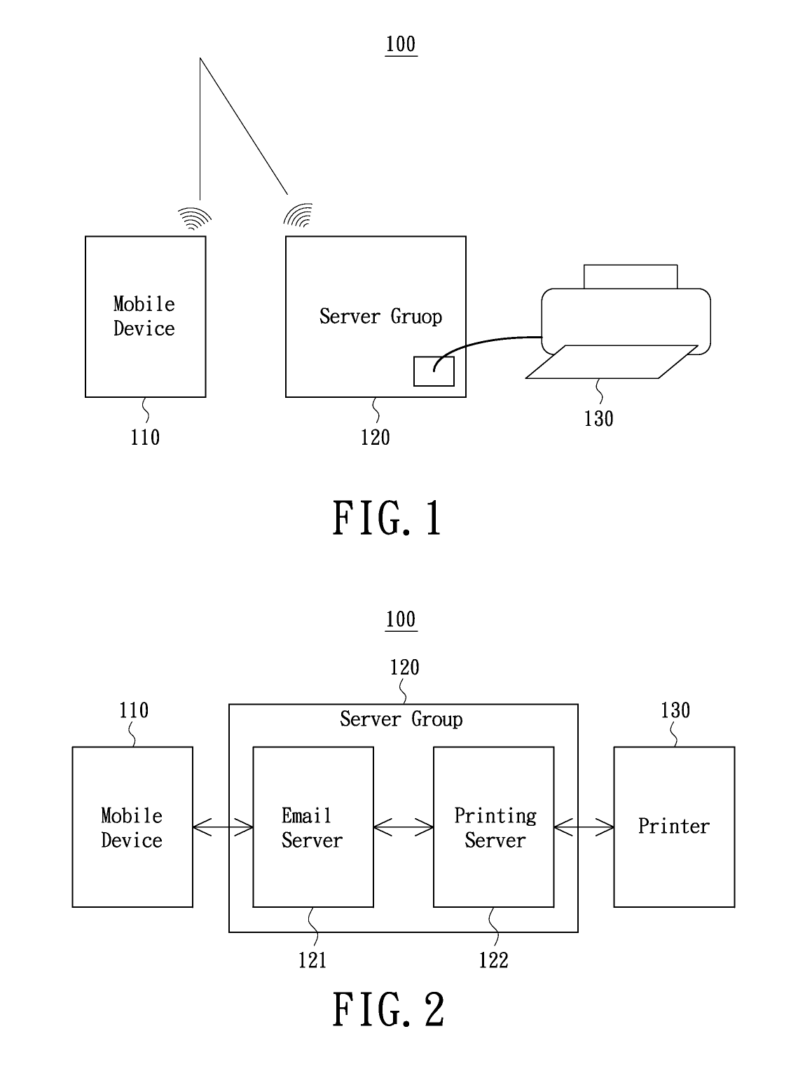

Refer to FIGS. 1 and 2, wherein FIG. 1 is a schematic view of an electronic system in accordance with an exemplary embodiment of the present invention, and FIG. 2 is a block view of the electronic system as shown in FIG. 1. As shown in FIGS. 1 and 2, the electronic system 100 comprises a mobile device 110, a server group 120 and a printer 130. The mobile device 110 is configured for sending a file, and the server group 120 is configured for receiving the file from the mobile device 110 and drives the printer 130 to print the file.

The mobile device 110 may be a portable device with an operation processing function, such as a personal digital assistant (PDA), a mobile phone, a smart phone, a pocketable computer, an e-book reader, etc. The file may be an image document, a word document, or an email document, etc.

The server group 120 may comprise an email server 121 and a printing server 122. In this exemplary embodiment, the mobile device 110 may send the file as an email to the email server 121. The printing server 122 has a scanning driver and a printing driver installed therein such that the printing server 122 can employ the scan driver to scan the email for determining whether printing the file, and employ the printing driver to drive the printer 130 for printing the file if the file should be printed. Preferably, the file may be used as an attachment of the email such that the file can be sent from the mobile device 110 to the email server 121.

In addition, the mobile device 110 may send the file as the email to the email server 121 by a wireless communication protocol, such as an 802.11 wireless communication protocol or a Bluetooth communication protocol, etc. Of course, it is understood for persons skilled in the art that, the mobile device 110 also may send the file as the email to the email server 121 by a wire communication protocol. The printing server 122 is communicated with the email server 121 such that after the email server 121 receives the email attaching the file, the printing server 122 scans the email to determine whether the email has a predetermined content, such as a predetermined word-string. If the email has the predetermined content, the printing server 122 drives the printer 130 to print the file by the printing driver. Preferably, the email server 121 and the printing server 122 may be integrated into a server, that is, the server not only can perform the function of the email server 121, but also can perform the function of the printing server 122. Alternatively, the email server 121 and the printing server 122 also may be two individual servers to combine the server group 120.

Furthermore, the printing server 122 may be included in an embedded bridging server, and an Operation System (OS) is installed in the embedded bridging server such that the scanning driver and the printing driver may run in the Operation System. The Operation System may be the Linux System, of course, it also may be the Windows System. The printing server 122 is further electrically coupled to the printer 130, for example, they are connected together through a wire interface, such as an Universal Serial Bus (USB) interface.

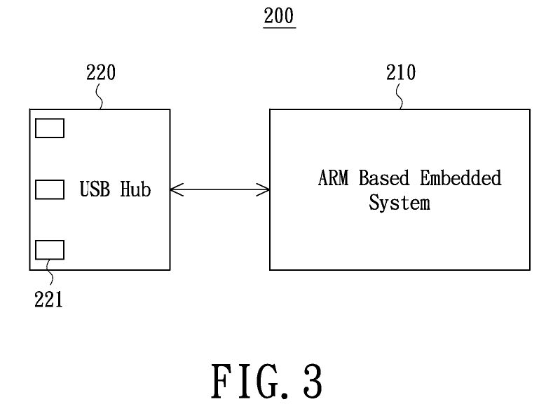

Refer to FIG. 3, which is a schematic view of the embedded bridging server. The embedded bridging server 200 may employ an Advanced RISC Machines (ARM) 32 bit platform to perform the related operation. In detail, the embedded bridging server 200 comprises an ARM based embedded system 210 and an USB hub 220. The ARM based embedded system 210 is configured for running the scanning driver and the printing driver, and the USB hub 220 is electrically coupled to the printer 130 such that the printing server 122 may drive the printer 130 to print the file by the printing driver. The USB hub 220 may comprise at least one USB interface 221 such that the printer 130 may be electrically coupled to the printing server 122 through the USB interface 220.

In summary, the electronic system 100 of the present invention installs the scanning driver and the printing driver in the printing server 120 instead of the mobile device 110, such that the scanning driver and the printing driver, specially the printing driver will not occupy the storing space of the mobile device 110, and not occupy the computing capability of the mobile device 110. Thus the mobile device 110 is still convenient in use.

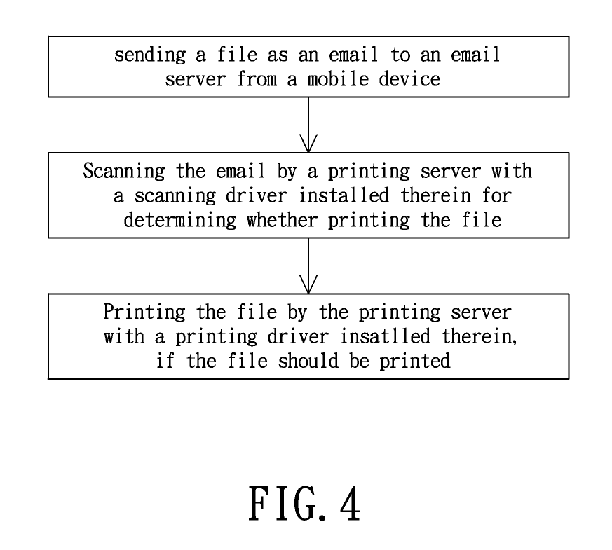

Furthermore, the present invention also provides a printing method for an electronic system. Refer to FIG. 4, which is a flow chart of the printing method for the electronic system in accordance with another exemplary embodiment of the present invention. The electronic system is described in FIGS. 1-2. The printing method comprises: sending a file as an email to an email server from a mobile device; scanning the email by a printing server with a scanning driver installed therein for determining whether printing the file; and printing the file by the printing server with a printing driver installed therein, if the file should be printed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic system, comprising:
a mobile device, sending a file;
a server group, receiving the file from the mobile device; and
a printer, electrically coupled to the server group;
wherein the server group comprises an email server and a printing server, the mobile device sends the file as an email to the email server of the server group, the printing server has a scanning driver and a printing driver installed therein such that the printing server employs the scanning driver to scan the email for determining whether printing the file, and employs the printing driver to drive the printer for printing the file if the file should be printed.

2. The electronic system according to claim 1, wherein the mobile device sends the file as the email to the email server of the server group by a wireless communication protocol.

3. The electronic system according to claim 2, wherein the wireless communication protocol comprises an 802.11 wireless communication protocol and a Bluetooth communication protocol.

4. The electronic system according to claim 1, wherein the file is used as an attachment of the email such that the file is sent from the mobile device to the email server of the server group.

5. The electronic system according to claim 1, wherein the mobile device is selected from a group consisted of a personal digital assistant, a mobile phone, a smart phone, a pocketable computer and an e-book reader.

6. The electronic system according to claim 1, wherein the email server and the printing server are integrated together.

7. The electronic system according to claim 1, wherein the email server and the printing server are two individual servers.

8. The electronic system according to claim 1, wherein the printing server employs the scanning driver to scan whether the email has a predetermined content, and if the email has the predetermined content, the printing server drives the printer to print the file by the printing driver.

9. The electronic system according to claim 8, wherein the predetermined content is a predetermined word-string.

10. The electronic system according to claim 1, wherein the printing server is included in an embedded bridging server.

11. The electronic system according to claim 10, wherein the embedded bridging server has an Operation System installed therein such that the scanning driver and the printing driver run in the Operation System.

12. The electronic system according to claim 11, wherein the Operation System is the Linux System.

13. The electronic system according to claim 12, wherein the embedded bridging server comprises an ARM (Advanced RISC Machines) 32 bit platform.

14. The electronic system according to claim 13, wherein the embedded bridging server comprises:
an ARM based embedded system, configured for running the scanning driver and the printing driver;
an USB hub, electrically coupled to the printer.

15. The electronic system according to claim 14, wherein the USB hub comprise at least one USB interface for being electrically coupled to the printer.

16. A printing method for an electronic system, comprising:
sending a file as an email to an email server from a mobile device;
scanning the email in the email server by a printing server with a scanning driver installed therein for determining whether printing the file; and
printing the file by the printing server with a printing driver installed therein, if the file should be printed.

17. The printing method according to claim 16, wherein the file is used as an attachment of the email such that the file is sent from the mobile device to the email server.
